(19) United States
(12) Patent Application Publication
(10) Pub. No.: US 2014/0121427 A1
(43) Pub. Date: May 1, 2014

(54) Methods of Activating Metal Complexes for Catalysts

(71) Applicants: Alexander Katz, Richmond, CA (US); Ron C. Runnebaum, Sacramento, CA (US); Alexander Okrut, San Francisco, CA (US); Xiaoying Ouyang, El Cerrito, CA (US); Igor Busygin, Berkeley, CA (US)

(72) Inventors: Alexander Katz, Richmond, CA (US); Ron C. Runnebaum, Sacramento, CA (US); Alexander Okrut, San Francisco, CA (US); Xiaoying Ouyang, El Cerrito, CA (US); Igor Busygin, Berkeley, CA (US)

(73) Assignee: The Regents of the University of California, Oakland, CA (US)

(21) Appl. No.: 14/065,302

(22) Filed: Oct. 28, 2013

Related U.S. Application Data
(60) Provisional application No. 61/719,840, filed on Oct. 29, 2012.

(51) Int. Cl. B01J 31/24; C07F 19/00

(52) U.S. Cl. CPC B01J 31/2409; C07F 19/00
USPC 585/275; 502/150; 502/162; 556/16

(57) ABSTRACT

The present invention is directed to the activation of metal carbonyl clusters by an oxidative agent to prepare a stable metal cluster catalyst exhibiting catalytic rate enhancement. The activation comprises, for example, using oxygen for decarbonylation of carbonyl ligands and changing the oxidation state of the other ligands. In one aspect, treatment of the metal cluster catalyst under oxidative conditions in a flow reactor leads to removal of CO ligands and oxidation of bound calixarene phosphine ligands, and results in a stable activated open metal cluster that is more active for ethylene hydrogenation catalysis. The resulting metal cluster contains coordinatively unsaturated sites comprising carbonyl vacancies. In one aspect, the resulting activated open metal cluster can be used as a catalyst in a variety of chemical transformations.

### CROSS-REFERENCE TO RELATED APPLICATIONS

The present application claims priority from U.S. Provisional Patent Application No. 61/719,840, filed on Oct. 29, 2012, entitled “Methods of Activating Metal Complexes for Catalysis”, the contents of which is hereby incorporated by reference in its entirety.

### BACKGROUND OF THE INVENTION

1. Field of the Invention

Provided are methods for activating metal clusters. More specifically, provided are processes for activating Ir₄ carbonyl clusters carrying phosphine ligands by using oxygen resulting in an activated, open Ir₄ cluster. The resulting activated metal cluster contains a coordinatively unsaturated site comprising carbonyl vacancies and achieves catalytic rate enhancement.

2. Description of the Related Art

Increasing catalytic activity, particularly for hydrogenation catalysts, is always a valued goal. There are reports of oxidative activation of catalyst sites for homogeneous cationic complexes used in hydrosilylation. See, Organosilicon Chemistry. Part 24. Homogeneous Rhodium-catalysed Hydrosilation of Alkenes and Alkynes: The Role of Oxygen or Hydroperoxides by Parish et al. in J C S Dalton 1980, 308-313) and hydrogenation reactions (Pentamethylcyclopentadienyl-Rhodium and-Iridium Complexes Part 35 Hydrogenation Catalysts Based on [(RhC₅Me₅)₂(OH)₃) And The Border Between Homogeneous and Heterogeneous Systems by Maitlis et al. in J Mol. Cat. 1982, 15, 337-347. These studies are preceded by reports of increased hydrogenation activity after oxygen treatment; for instance, a 100-fold increase in hydrogenation activity of maleic acid is observed upon treating the homogeneous trans-IrX(CO)(PPh₃)₂, where X═Cl, Br complex with small amounts of oxygen (Kinetic study of iridium (I) complexes as homogeneous hydrogenation catalysts by James and Memon in Can J. Chem. 1968, 46:217-223). Both the Parish et al. and Maitlis et al. manuscript attribute the role of oxygen treatment as one that removes ligands (e.g., oxidizes triphenylphosphine to triphenylphosphine oxide), thereby creating a coordinatively unsaturated center that is catalytically active. The Maitlis et al. article articulates how such species are unstable and readily aggregate into larger particles in general.

The oxidative treatment has been previously used to activate soluble metal complexes for catalysis. See James, B. R.; Memon, N. A. Can. J. Chem. 1968, 46, 217-23, Strohmeier, W.; Hitzel, E. J. Organomet. Chem. 1975, 102, C37-41, van Bekkum, H.; van Rantwijk, F.; van de Putte, T. Tetrahedron Lett. 1969, 1, 1-2 and Dickers, H. M; Haszeldine, R. N.; Malkin, L. S.; Mather, A. P.; Parish, R. V. J. C. S. Dalton 1980, 308-13. However, when oxidative treatment is used on the clusters, it typically results in a cluster that, after oxidative treatment, is unstable and rapidly deactivates during catalysis. This type of cluster instability has been identified to be a universal problem and limiting issue that prevents implementation of clusters as catalysts in practice. See X, Z.; Xiao, F.-S.; Purnell, S. K.; Alexeev, O.; Kawi, S.; Deutsch, S. E.; Gates, B. C. Nature 1994, 372, 346-48.

Ligands can also be removed using harsh thermal treatment to create open and catalytically active sites in metal clusters. See Gates Chem. Rev. 1995, 95, 511-22. However, such harsh thermal treatments are known to lead to unstable clusters under oxidative conditions and are incompatible with having a well-defined organic-ligand sphere complexed to the cluster. The ligands can also be treated in-situ to alter the catalytic activity of the metal cluster. Specifically, soluble metal complexes comprising most typically one and sometimes two metal atoms and containing phosphine ligands have been shown to become more catalytically active for alkene hydrogenation upon oxidation. This has been hypothesized to be due to oxidation of phosphine to phosphine oxide. See James, B. R.; Memon, N. A. Can. J. Chem. 1968, 46, 217-23, van Bekkum, H.; van Rantwijk, F.; van de Putte, T. Tetrahedron Lett. 1969, 1, 1-2 and Dickers, H. M; Haszeldine, R. N.; Malkin, L. S.; Mather, A. P.; Parish, R. V. J C. S Dalton 1980, 308-13). This phosphine oxidation is hypothesized to open up a previously occupied coordination site on the metal for reactant binding and catalysis.

An objective of the present invention is to provide a simple and efficient activation of a metal cluster, open or closed, comprising a metal polyhedra, which results in an activated metal cluster after activation. The activated metal cluster is useful as a catalyst, is stable, and demonstrates improved catalytic activity

### SUMMARY OF THE INVENTION

Provided is a method for the activation of a metal carbonyl cluster for catalysis using an oxidative treatment. The resulting activated cluster is stable and can achieve catalytic rate enhancement. The method comprises reacting the metal carbonyl cluster, either closed or open, with an oxidative agent, with the oxidative agent reacting with a bound carbonyl group so as to unbind it from the cluster and leave behind other ligands in a different oxidation state. In one aspect, the metal cluster is supported on a catalytic support. The supported metal cluster is reacted with an oxidative agent in a flow reactor, with the oxidative agent reacting with a bound carbonyl group so as to unbind it from the cluster leaving behind a reactive coordinatively unsaturated site and other ligands in a different oxidation state. The resulting activated open metal cluster is used for catalysis and exhibits enhanced catalytic rate. In one aspect, the metal cluster is activated by using oxygen as an oxidative agent. Upon reacting the metal cluster with an oxidative agent, CO groups are removed, and other ligands may transform into a different oxidative state.

In one aspect, the activated open metal cluster involves having one or more carbonyls on the cluster missing. In one aspect, the site formerly held by the missing carbonyls is a coordinatively unsaturated site which is a CO vacancy. In an alternate embodiment, the closed metal cluster comprises one or more phosphine ligands. One or more of these phosphine ligands is oxidized via oxidative treatment to synthesize phosphine oxide, which are easily labile ligands and create an open site on the cluster in this fashion. In one embodiment, the activated open metal cluster is an open Ir₄ cluster bound with three calixarene phosphine ligands for steric protection against aggregation.

Among other factors, it has been found that an open metal cluster can be prepared by means of a chemical reaction between an oxidative agent and metal carbonyl cluster, without the need for a thermal supported reaction that are known to lead to unstable clusters under oxidative conditions and are incompatible with having a well-defined organic-ligand sphere complexed to the cluster. The resulting activated metal cluster is stable and exhibits catalytic rate enhancement, particularly for hydrogenation reactions. The metal carbonyl cluster reacted with the oxidative agent is generally a closed metal carbonyl cluster, but further activation of an open cluster with the oxidative treatment has been found to surprisingly further enhance the catalytic rate. In one aspect, the present process permits removal of carbonyl groups and oxidation of phosphine ligands. In one aspect, the activated open metal clusters are free of aggregation by employing calixarene phosphine ligands for steric protection. The resulting activated open metal clusters have a coordinatively unsaturated site comprising carbonyl vacancy that acts as a highly active catalyst site. These sites are useful in catalysis and render the activated open metal cluster an effective catalyst. In one aspect, the activated open metal clusters serve as catalysts for hydrogenation reactions.

### BRIEF DESCRIPTION OF THE DRAWINGS

FIGS. 1A, 1B and 1C Schematic illustration of trisubstituted Ir₄ carbonyl parent cluster having formula Ir₄(CO)₉L₃ and consisting of both bridging and terminal CO ligands (FIG. 1A); calixarene phosphine L ligand used in synthesis of cluster L₃ (FIG. 1B); and sterically less bulky ligand L′ (FIG. 1C) used for synthesis of cluster L₃′.

FIGS. 2A and 2B graphically depict ethane formed during ethylene hydrogenation catalysis as a function of time on stream. Reaction conditions were 50° C., ambient pressure, and a total flow rate of 63 mL/min (16% H₂, 5% C₂H₄ balance He). Data for catalyst L₃ @ SiO₂-500 are shown in FIG. 2A, and for catalyst L₃′ @ SiO₂-500 are shown in FIG. 2B. Catalytic activities are reported as rate of reaction per total Ir atom (turnover frequency, TOF). These data sets show both catalysts to be stable at 50° C. during ethylene hydrogenation reaction conditions, as shown by the steady-state formation of ethane.

FIGS. 3A-3D show in-situ FTIR spectroscopy of Ir4-based catalysts supported on SiO₂-500 during ethylene hydrogenation catalysis (reaction conditions: 50° C., ambient pressure and a total flow rate of 63 mL/min (16% H₂, 5% C₂H₄, balance He)) followed by CO treatment at 50° C. to affect recarbonylation. Data for catalyst L₃ @ SiO₂-500 are shown in FIGS. 3A and 3C, and for catalyst L₃′ @ SiO₂-500 are shown in FIGS. 3B and 3D. These data sets show both catalysts to be stable at 50° C. during ethylene hydrogenation reaction conditions, as shown by the complete recovery of the IR bands during recarbonylation.

FIGS. 4A and 4B show the stability of L₁ @ SiO₂-500 characterized by ethylene hydrogenation catalysis (FIG. 4A) and solid-state ³¹P NMR (FIG. 4B). Ethane formed during ethylene hydrogenation catalyzed by L₁ @ SiO₂-500 as a function of time on stream. In the main figure, reaction conditions were 50° C., ambient pressure, and total flow rate of 63 mL/min (16% H₂, 5% C₂H₄ balance He). In the inset figure, reaction conditions were 35° C., ambient pressure, and total flow rate of 63 mL/min (16% H₂, 5% C₂H₄ balance He). Catalytic activities are reported as rate of reaction per total Ir atom (turnover frequency, TOF). In FIG. 4B, there is shown ³¹P CP MAS NMR data characterizing L₁ @ SiO₂-500 (A) as-made, (B) after C₂H₄ hydrogenation at 35° C., and (C) after C₂H₄ hydrogenation at 50° C. These data sets show the catalyst to be unstable at 50° C. during ethylene hydrogenation reaction conditions.

FIGS. 5A and 5B Graphically depict ethane formed during ethylene hydrogenation catalysis as a function of time on stream. Reaction conditions were 50° C., ambient pressure, and total flow rate of 63 mL/min (16% H₂, 5% C₂H₄ balance He). Pre-treatment consisted of an initial 24 hours of ethylene hydrogenation catalysis (as shown in Example 2) and subsequent 12 hours of oxidation treatment. Data for catalyst L₃ @ SiO₂-500 are shown in FIG. 5A, and for catalyst L₃′ @ SiO₂-500 are shown in FIG. 5B. Catalytic activities are reported as rate of reaction per total Ir atom (turnover frequency, TOF). These data sets show (i) both catalysts to be more active after oxidation treatment, and (ii) catalyst L₃ @ SiO₂-500 to be stable and catalyst L₃′ @ SiO₂-500 to be unstable at 50° C. during ethylene hydrogenation reaction conditions after oxidation treatment.

FIGS. 6A-6D show in-situ FTIR spectroscopy of Ir₄-based catalysts supported on SiO₂-500 during (i) ethylene hydrogenation catalysis followed by (ii) oxidation treatment, (iii) further ethylene hydrogenation catalysis, and then by (iv) CO treatment to affect recarbonylation; temperature was maintained at 50° C. Data for catalyst L₃ @ SiO₂-500 are shown in FIGS. 6A and 6C, and (c) and for catalyst L₃′ @ SiO₂-500 are shown in FIGS. 6B and 6D. These data sets show (i) oxidation affects changes that are not reversible for both catalysts, as shown by the lack of recovery of the IR bands during recarbonylation, and (ii) ethylene hydrogenation catalysis by L₃ @ SiO₂-500 to be stable, as shown by the stability of the terminal carbonyl ligands and terminal CO band wavenumber during catalysis. Ethylene hydrogenation catalysis conditions were 50° C., ambient pressure, and total flow rate of 63 mL/min (16% H₂, 5% C₂H₄ balance He).

FIG. 7 shows in-situ FTIR spectroscopy of L₃ @ SiO₂-500 during ethylene hydrogenation catalysis at 50° C., ambient pressure, and total flow rate of 63 mL/min (16% H₂, 5% C₂H₄ balance He), followed by dry air treatment to affect oxidation and then by CO treatment to affect recarbonylation (terminal CO band intensity, (▪); terminal CO band wavenumber, (◯)). This data set suggests that oxidation irreversibly changes the catalyst (by lack of recovery of the terminal CO band intensity) but maintains the stability of the metal cluster (by the recovery of the terminal CO band wavenumber).

FIG. 8 shows ³¹P CP MAS NMR data characterizing L₃ @ SiO₂-500 (A) as-made in Example 1, (B) Example 2 after C₂H₄ hydrogenation catalysis, and (C) Example 4 after the sequence of initial C₂H₄ hydrogenation catalysis, oxidation treatment, and subsequent C₂H₄ hydrogenation catalysis. These data sets show that L₃ @ SiO₂-500 to be stable after ethylene hydrogenation catalysis in Example 2 (B) and to be irreversibly changed by a shift of resonance in the spectrum to that of phosphine oxide in Example 4 (after the sequence of initial C₂H₄ hydrogenation catalysis, oxidation treatment, and subsequent C₂H₄ hydrogenation catalysis) (C).

### DETAILED DESCRIPTION OF THE INVENTION

The present invention provides a general method for the activation of metal carbonyl clusters, which in one embodiment are bound by with three calixarene phosphine ligands for steric protection against aggregation. Open metal carbonyl clusters are clusters containing metal bonds to a bound carbonyl, which cluster can also contain other ligands such as phosphine, carbene, etc. The activated open metal clusters comprise a coordinatively unsaturated site consisting of CO vacancy. The synthesis of the activated open metal cluster requires an oxidative agent such as oxygen. Any suitable oxidative agent can be used for the treatment, but oxygen is particularly practical and effective. Peroxides, hypochlorides and permanganates are examples of other useful oxidative agents.

By an “activated open” metal cluster is meant for the purposes of the present invention having carbonyls of the metal cluster missing and different oxidation state of other ligands compared to their original oxidation state. The sites formerly held by the missing carbonyls are a vacant site altogether.

An activated open metal cluster, for the present purposes, is one where after the activated open metal cluster is used in catalysis, the site that used to be occupied by CO after oxidation, is able to be readily recarbonylated and reoccupied upon treatment with CO. This can be done, for example, upon treating the cluster with CO gas at catalytic reaction condition. If rebinding of the CO is not readily accomplished, the cluster is not considered stable catalyst.

The “activated open” nature of the metal cluster has been found possible by treating closed metal cluster with an oxidative agent such as oxygen to create the open sites and simultaneously oxidize other ligands. In general, the activating agent can be any oxygen-containing compound coordinating through oxygen. As noted above, the activated open metal clusters of the present invention can be regenerated after it has been used for catalysis by binding CO ligands to the open sites, e.g., upon treating the cluster with CO gas at catalytic reaction condition.

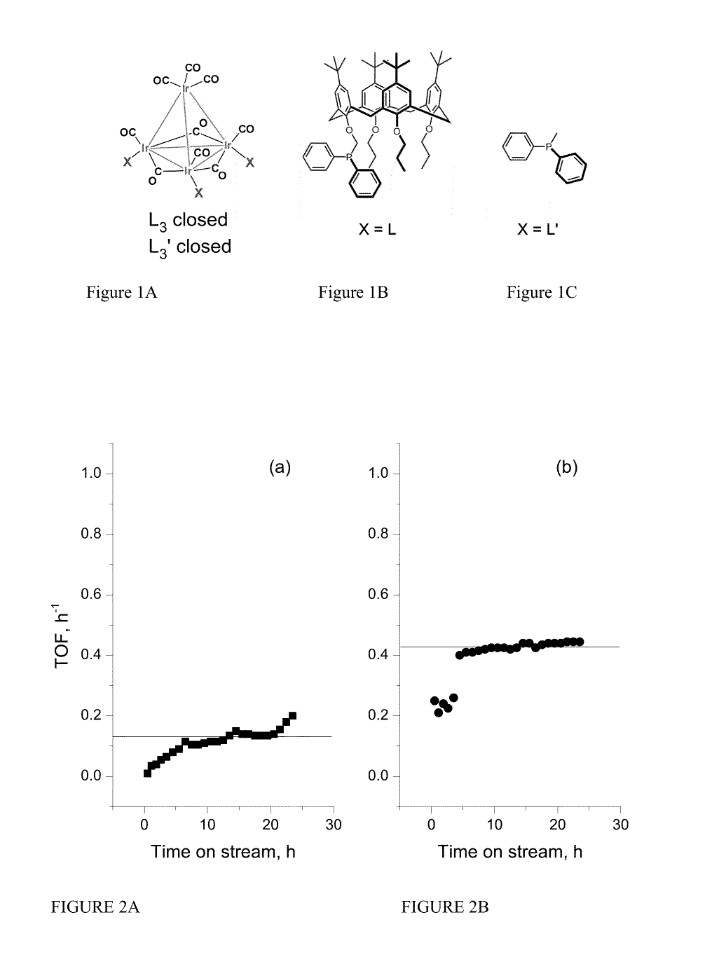

The example below demonstrates a present synthesis of a silica-supported closed metal cluster that is bound with three phosphine ligands. As a comparison of the two clusters L and L′ as defined in FIGS. 1A-1C shows, a sterically bulky calixarene phosphine ligand is important for preserving the stability of the ensuing open cluster. When the ligand is replaced with a smaller, less sterically demanding diphenylmethylphosphine (PPh₂Me), for example, the resulting activated open metal cluster after oxidative activation is not stable after oxidative treatment.

The catalytic activity of closed metal clusters was determined by using closed metal clusters supported on a silica support. An example of a typical procedure for silica-supported organometallic cluster catalysts comprising of either L₃ and L₃′ is as follows: (1) silica (Degussa, Aerosil 200) was hydroxylated with deionized water by stirring and refluxing the slurry for 24 hours, (2) the slurry was cooled to room temperature and then centrifuged at 10000 rpm to separate the solid phase from the supernatant, (3) the silica paste was dried under vacuum at 200° C. for 15 hours and subsequently crushed into a powder, (4) silica powder was calcined under dry air at 500° C. for 4 hours followed by inert gas at 500° C. for 10 hours, (5) the tetrairidium carbonyl cluster precursor (e.g., L₃ or L₃′) was dissolved in n-hexane (EMD Chemicals, anhydrous 95%, and dried in sodium bezophenone ketyl) in a Schlenk flask and adsorbed onto the calcined silica by stirring the mixture at room temperature (approximately 23° C.) for 1 hour until the solution became colorless, (6) the solvent was evacuated under vacuum (15 mtorr) for 24 hours. Each catalyst contained about 1.0 wt % Ir. The synthesized material was stored in a glove box and subsequently handled by using moisture- and air-free techniques. The silica-supported tetrairidium carbonyl clusters are subsequently named L₃ @ SiO₂-500 and L₃′ @ SiO₂-500.

The catalytic activity of L₃ @ SiO₂-500 and of L₃′ @ SiO₂-500 (both as-made) was tested for ethylene hydrogenation. The reactions were carried out in once-through packed-bed flow reactors at a temperature of 50° C. and atmospheric pressure. The packed bed (250 mg of catalyst) was loaded into a u-shaped reactor (with air-free stopcock closures) in an argon-filled glovebox, and installed into the flow system to avoid contacting the catalyst with air. The process lines, and subsequently the packed bed, were purged with He (99.999% purity). The temperature was measured by using a thermocouple placed inside the reactor and immediately upstream of the packed bed. The reactant gases (10 mL/min H₂ and 3 mL/min C₂H₄) were diluted in a stream of He flowing at 50 mL/min. An online MKS FTIR (Multigas 2030) was used to analyze the reaction products.

The activity of the as-made catalysts is immediate but relatively low, see FIGS. 2A and 2B. The activity exhibited an average TOF of 0.13 h⁻¹ for L₃ @ SiO₂-500 and 0.43 h⁻¹ for L₃′ @ SiO₂-500. Both catalysts were stable (i.e., no deactivation) for times of stream of more than 12 hours.

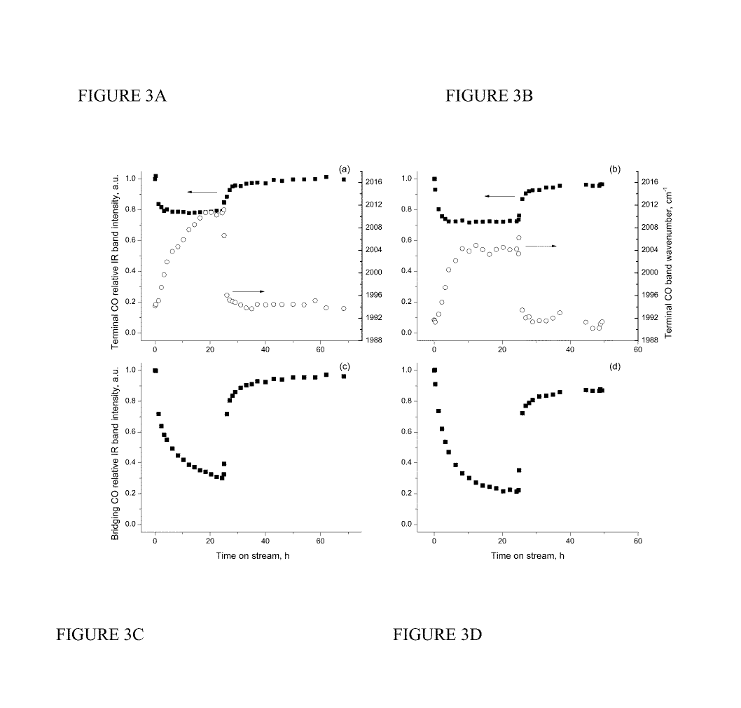

Next, the stability of these as-made catalysts is shown by following ethylene hydrogenation catalysis and recarbonylation by CO treatment processes using in-situ (time-resolved) solid-state FTIR spectroscopy as shown in FIGS. 3A-3D for 1787 cm⁻¹ (bridging) and 1988 cm⁻¹ (terminal) band intensity and wavenumber. Recarbonylation of L₃ @ SiO₂-500 is demonstrated during CO treatment by the recovery of the terminal (FIG. 3A) and bridging (FIG. 3C) IR band intensities, and by the return of the terminal CO band wavenumber (FIG. 3A). These data demonstrate for L₃ @ SiO₂-500 that the active site is still accessible and that the catalyst is stable. Recarbonylation of L₃′ @ SiO₂-500 is demonstrated during CO treatment by the recovery of the terminal (FIG. 3B) and bridging (FIG. 3D) IR band intensities, and by the return of the terminal CO band wavenumber (FIG. 3B). The ability to recarbonylate after ethylene hydrogenation demonstrates for L₃′ @ SiO₂-500 that the active site is still accessible and that the catalyst is stable.

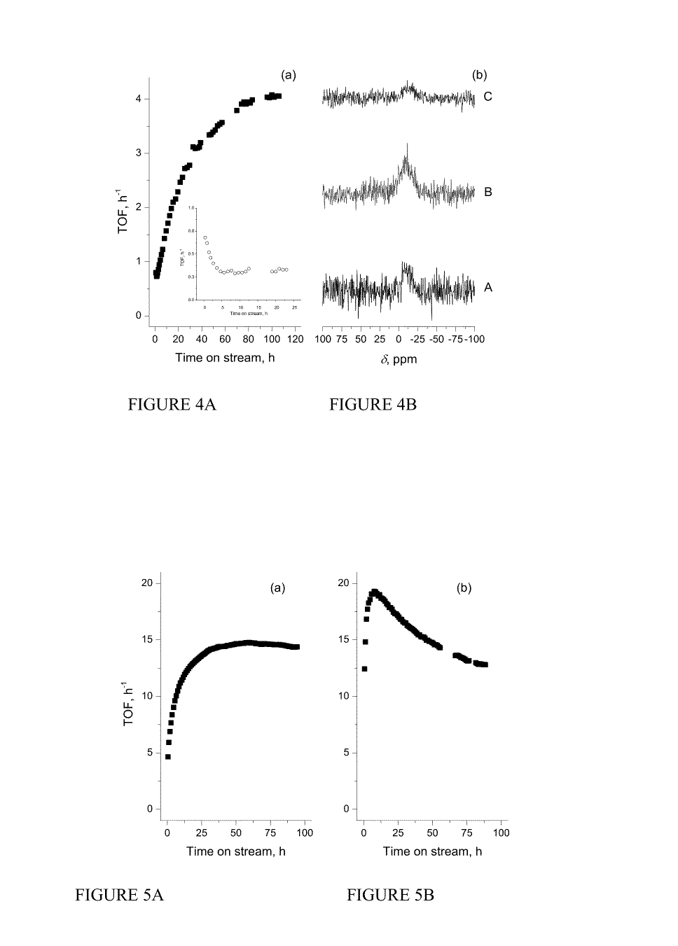

The utility of three sterically bulky groups such as calixarene phosphine for cluster stability can be demonstrated by the instability exhibited at higher temperature by a metal cluster having only one calixarene phosphine ligand. As a comparison, L₁ @ SiO₂-500, which contains only one bulky calixarene phosphine ligand on the Ir₄ cluster, is not stable even during ethylene hydrogenation catalysis, as shown by the lack of steady-state ethane formation (FIG. 4A) and disappearance of the ³¹P NMR resonance at −10 ppm (FIG. 4B, comparison of A and C). This catalyst is stable, however, at 35° C., as shown by steady-state ethane formation (FIG. 4A inset graph) and stability of the ³¹P NMR resonance at −10 ppm (FIG. 4B comparison of A and B).

The example below demonstrates a present synthesis of an activated open Ir₄ cluster that is bound with three oxidized calixarene phosphine ligands. As a comparison of the two clusters L and L′ as defined in FIGS. 1A to 1C shows, a sterically bulky calixarene phosphine ligand is important for preserving the stability of the ensuing open cluster. When the ligand is replaced with a smaller, less sterically demanding diphenylmethylphosphine (PPh₂Me), for example, cluster instability can ensue upon synthesizing an activated open metal cluster.

The reactions were carried out in once-through packed-bed flow reactors at a temperature of 50° C. and atmospheric pressure. The packed bed (250 mg of catalyst L₃ @ SiO₂-500 and L₃′ @ SiO₂-500) was loaded into a u-shaped reactor (with air-free stopcock closures) in an argon-filled glovebox, and installed into the flow system to avoid contacting the catalyst with air. The process lines, and subsequently the packed bed, were purged with He (99.999% purity). The temperature was measured by using a thermocouple placed inside the reactor and immediately upstream of the packed bed. The reactant gases (10 mL/min H₂ and 3 mL/min C₂H₄) were diluted in a stream of He flowing at 50 mL/min. After maintaining the above conditions for 24 hours, the catalyst were subjected to a 12 hours oxidation treatment with extra dry air (Praxair, AI0.0XD) flowing at 60 mL/min and He (Praxair, 99.999% purity) flowing at 10 mL/min. The packed bed temperature was maintained at 50° C. and ambient pressure. The resulting activated open metal clusters were used as is.

One example of the utility and stability of the activated L₃ @ SiO₂-500 containing an Ir₄ cluster is shown in the hydrogenation of ethylene. After the oxidation treatment, both catalysts (L₃ @ SiO₂-500 and L₃′ @ SiO₂-500) were more active for ethylene hydrogenation catalysis, as shown in FIGS. 5A and B. The catalytic activity for activated L₃ @ SiO₂-500, shown in FIG. 5A, increases to achieve a new pseudo-steady state after 36 hours time on stream. The catalytic activity for activated L₃′ @ SiO₂-500, shown in FIG. 5B, abruptly increases to a new maximum at less than 12 hours time on stream, and undergoes subsequent deactivation. The formation of ethane was increased by more than two orders of magnitude (Table 1) when comparing the rate in the first catalytic cycle (prior to oxidation treatment) with the rate after oxidation treatment for the catalyst L₃ @ SiO₂-500. These data show that the L₃ @ SiO₂-500 catalyst, which is sterically protected, can be activated by oxidation (in this instance via dry air) to create an active and stable catalyst. In comparison, performing a similar treatment on L₃′ @ SiO₂-500 results in an unstable catalyst, which continues to deactivate indefinitely according to the data in FIG. 5B. Due to this deactivation of L₃′ @ SiO₂-500, the activity of this catalyst is already 10% lower at t=80 hours relative to L₃ @ SiO₂-500.

TABLE 1
Formation of ethane in the hydrogenation of ethylene catalyzed by
Ir₄-based catalysts first used in Example #1 and then
subject to an oxidation treatment prior to further ethylene
hydrogenation catalysis for 90 hours time on stream. Temperature
of the catalyst was maintained at 50° C.

| | L₃ @ SiO₂-500 | | L₃′ @ SiO₂-500 | |
|---|---|---|---|---|
| | | After O₂ | | After O₂ |
| | Before O₂ | treatment and at | Before O₂ | treatment and at |
| | treatment | t = 80 h | treatment | t = 80 h |
| TOF^{a}, h⁻¹ | 0.13 | 14.5 | 0.43 | 12.9 |

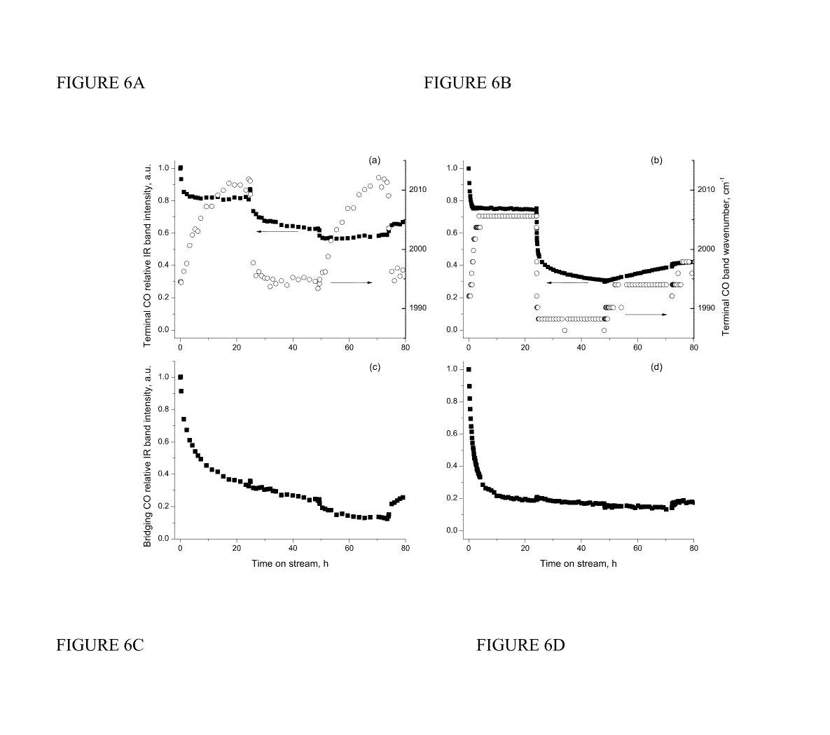

The stability of these catalysts (L₃ @ SiO₂-500 and of L₃′ @ SiO₂-500) can also be shown using solid-state FTIR spectroscopy for the sequence of ethylene hydrogenation catalysis, oxidation, ethylene hydrogenation catalysis, and then recarbonylation. These data are shown in FIGS. 6A to 6D for 1787 cm⁻¹ (bridging) and 1988 cm⁻¹ (terminal) band intensity and wavenumber. The catalyst was first used for ethylene hydrogenation catalysis for 24 hours at 50° C. (as was done in FIGS. 3A-3D), and then subjected to an oxidation treatment (60 mL/min dry air diluted in 10 mL/min He; T=50° C.) for 24 hours. A subsequent period of ethylene hydrogenation catalysis for 24 hours, by using the same reaction conditions as in FIGS. 5A-5B was performed prior to a final CO treatment (T=50° C.) to affect recarbonylation. These data sets show, for the catalyst L₃ @ SiO₂-500, terminal and bridging CO band intensities recover to their post-oxidation levels, which indicates that the catalyst is stable, as shown in FIGS. 6A and 6C. These band intensities were also stable during ethylene hydrogenation catalysis. The terminal CO band wavenumber was the same before and after the second ethylene hydrogenation catalysis period (FIG. 6A), which suggests that the stability of the metal cluster was maintained.

In contrast, the terminal CO band intensity for the catalyst L₃′ @ SiO₂-500 was not stable during the second ethylene hydrogenation catalysis (FIG. 6B) as the relative intensity increased from 0.3 to 0.4. The terminal CO band wave number observed after recarbonylation differed from the value observed prior to the second ethylene hydrogenation (FIG. 6B). These data are consistent with L₃′ @ SiO₂-500 being an unstable catalyst for ethylene hydrogenation after oxidation treatment.

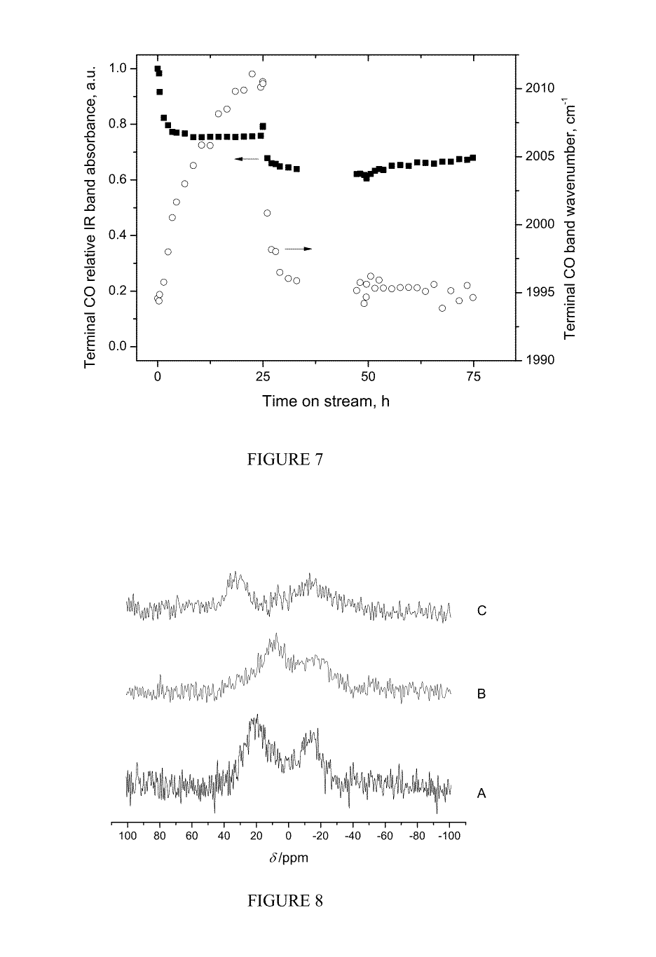

The activation such as oxidation also irreversibly changed the metal cluster. The change affected by the oxidation treatment can be shown by following the decarbonylation during an oxidation treatment and recarbonylation by CO treatment processes using in-situ (time-resolved) solid-state FTIR spectroscopy as shown in FIG. 7 for 1988 cm⁻¹ (terminal) band intensity and wavenumber. The catalyst, L₃ @ SiO₂-500, was subject to initial ethylene hydrogenation catalysis (as in FIGS. 3A-3D) and subsequent oxidation by flowing dry air (as in FIGS. 6A-6D) and recarbonylation by flowing CO (as in both FIGS. 3A-3D and 6A-6D). After oxidation treatment, the terminal CO relative IR band intensity does not recover to its as-made value, which indicates that oxidation affected an irreversible change in the catalyst. The terminal CO band wave number did recover to its as-made value suggesting that the stability of the metal cluster (and its interaction with the CO ligands) was maintained.

The stability and the irreversible changes to the catalyst L₃ @ SiO₂-500 after activation was followed by ³¹P NMR characterizing as-made catalyst, as-made catalyst after C₂H₄ hydrogenation catalysis, and as-made catalyst after the sequence of initial C₂H₄ hydrogenation catalysis, and oxidation treatment (FIG. 8). The spectrum characterizing the catalyst after initial ethylene hydrogenation catalysis (B) is similar to that of the as-made material (A), which is indicative of a stable catalyst, and reaffirms the conclusions drawn from data in FIGS. 2A-2B and 3A-3D. The catalyst sample from after oxidation treatment and a second period of ethylene hydrogenation catalysis (C) is characterized by the disappearance of resonance in the spectrum near 18 ppm, which represents oxidation of the two equatorial CO ligands, and by the appearance of a resonance in the spectrum near 33 ppm. Resonance in the range of 24-35 ppm can be attributed specifically to phosphine oxide functionality. The downfield ³¹P shift in C vs. A and B is attributed to the oxidation of phosphine. These data indicate that the catalyst has been irreversibly changed by oxidation characterized by a shift in the resonance in the spectrum to that of phosphine oxide. These data are consistent with data in FIGS. 6A-6D and 7, which shows oxidation treatment affected an irreversible change that prevented recovery of the carbonyl band intensities to those observed prior to oxidation.

Other treatment conditions can affect the catalytic activity of the catalyst L₃ @ SiO₂-500. The catalyst following the sequence of catalysis, oxidation, and further catalysis was further exposed to pure C₂H₄ for 2 hours at 50° C. Subsequently, the catalytic activity for ethylene hydrogenation of the catalyst is measured (reaction conditions were the same as those used above). The formation of ethane was increased by more than 25% (Table 2), from 1241 to 1576 ppm ethane, when comparing the rate prior to C₂H₄ exposure. This example shows that use of other gas treatments after an oxidation and ethylene hydrogenation catalysis sequence can further enhance activity.

TABLE 2
Pseudo-steady state formation of ethane in the hydrogenation of
ethylene by L₃ @ SiO₂-500 used in Example #2,
BEFORE and AFTER exposure to pure C₂H₄.

| | BEFORE exposure | AFTER exposure |
|---|---|---|
| | to pure C₂H₄ | to pure C₂H₄ |
| Ethane formation, ppm | 1241 | 1576 |

The following examples are provided as specific illustrations, and are not meant to be limiting.

### Example 1

### Silica Supported (Subsequently Name SiO₂-500) Organometallic Cluster Catalysts Consisting of Either L₃ and L₃′ as Shown in FIGS. 1A-1C

Silica (Degussa, Aerosil 200) was hydroxylated with deionized water by stirring and refluxing the slurry for 24 hours. The resulting slurry was cooled to room temperature and then centrifuged at 10000 rpm to separate the solid phase from the supernatant. The resulting silica paste was dried under vacuum at 200° C. for 15 hours and subsequently crushed into a powder which was calcined under dry air at 500° C. for 4 hours followed by inert gas at 500° C. for 10 hours. The tetrairidium carbonyl cluster precursor (e.g., L₃ or L₃′) was dissolved in n-hexane (EMD Chemicals, anhydrous 95%, and dried in sodium bezophenone ketyl) in a Schlenk flask and adsorbed onto the calcined silica by stirring the mixture at room temperature (approximately 23° C.) for 1 hour until the solution became colorless. The solvent was evacuated under vacuum (15 mtorr) for 24 hours. Each resulting catalyst contained about 1.0 wt % Ir. The synthesized material was stored in a glove box and subsequently handled by using moisture- and air-free techniques. The silica-supported tetrairidium carbonyl clusters are named L₃ @ SiO₂-500 and L₃′ @ SiO₂-500.

### Example 2

### Catalytic Activity of L₃ @ SiO₂-500 and L₃′ @ SiO₂-500

The catalytic activity of L₃ @ SiO₂-500 and of L₃′ @ SiO₂-500 (both as-made) was tested for ethylene hydrogenation. The reactions were carried out in once-through packed-bed flow reactors at a temperature of 50° C. and atmospheric pressure. The packed bed (250 mg of catalyst) was loaded into a u-shaped reactor (with air-free stopcock closures) in an argon-filled glovebox, and installed into the flow system to avoid contacting the catalyst with air. The process lines, and subsequently the packed bed, were purged with He (99.999% purity). The temperature was measured by using a thermocouple placed inside the reactor and immediately upstream of the packed bed. The reactant gases (10 mL/min H₂ and 3 mL/min C₂H₄) were diluted in a stream of He flowing at 50 mL/min. An online MKS FTIR (Multigas 2030) was used to analyze the reaction products.

The activity of the as-made catalysts is immediate but relatively low (FIGS. 2A and 2B). The activity exhibited an average TOF of 0.13 h⁻¹ for L₃ @ SiO₂-500 and 0.43 h⁻¹ for L₃′ @ SiO₂-500. Both catalysts were stable (i.e., no deactivation) for times of stream of more than 12 hours.

### Example 3

### Stability of L₃ @ SiO₂-500 and L₃′ @ SiO₂-500

The stability studies of these as-made catalysts is measured by following ethylene hydrogenation catalysis carried out at 50° C., ambient pressure and a total flow rate of 63 mL/min (16% H₂, 5% C₂H₄, balance He), followed by recarbonylation by CO treatment processes at 50° C. using in-situ (time-resolved) solid-state FTIR spectroscopy as shown in FIGS. 3A-3D for 1787 cm⁻¹ (bridging) and 1988 cm⁻¹ (terminal) band intensity and wavenumber. Recarbonylation of L₃ @ SiO₂-500 is demonstrated during CO treatment by the recovery of the terminal (FIG. 3A) and bridging (FIG. 3C) IR band intensities, and by the return of the terminal CO band wavenumber (FIG. 3A). These data demonstrate for L₃ @ SiO₂-500 that the active site is still accessible and that the catalyst is stable. Recarbonylation of L₃′ @ SiO₂-500 is demonstrated during CO treatment by the recovery of the terminal (FIG. 3B) and bridging (FIG. 3D) IR band intensities, and by the return of the terminal CO band wavenumber (FIG. 3B). The ability to recarbonylate after ethylene hydrogenation demonstrates for L₃′ @ SiO₂-500 that the active site is still accessible and that the catalyst is stable.

### Example 4

### Activation of L₃ @ SiO₂-500 and L₃′ @ SiO₂-500

Catalysts L₃ @ SiO₂-500 and L₃′ @ SiO₂-500 were subjected to 24 hours of ethylene hydrogenation catalysis condition of example 2 followed by a 12 hours oxidation treatment with extra dry air (Praxair, AI0.0XD) flowing at 60 mL/min and He (Praxair, 99.999% purity) flowing at 10 mL/min. The packed bed temperature was maintained at 50° C. and ambient pressure.

### Example 5

### Catalytic Activity of Activated L₃ @ SiO₂-500 and L₃′ @ SiO₂-500

Both catalysts obtained from example 4 were separately subjected to 50° C., ambient pressure, and total flow rate of 63 mL/min (16% H₂, 5% C₂H₄ balance He).

Both catalysts were more active for ethylene hydrogenation catalysis, as shown in FIGS. 5A and 5B. The catalytic activity for L₃ @ SiO₂-500, shown in FIG. 5A, increases to achieve a new pseudo-steady state after 36 hours time on stream. The catalytic activity for L₃′ @ SiO₂-500, shown in FIG. 5B, abruptly increases to a new maximum at less than 12 hours time on stream, and undergoes subsequent deactivation. The formation of ethane was increased by more than two orders of magnitude (Table 1) when comparing the rate in the first catalytic cycle (prior to oxidation treatment) with the rate after oxidation treatment for the catalyst L₃ @ SiO₂-500. These data show that the L₃ @ SiO₂-500 catalyst, which is sterically protected, can be activated by oxidation (in this instance via dry air) to create an active and stable catalyst. In comparison, performing a similar treatment on L₃′ @ SiO₂-500 results in an unstable catalyst, which continues to deactivate indefinitely according to the data in FIG. 5B. Due to this deactivation of L₃′ @ SiO₂-500, the activity of this catalyst is already 10% lower at t=80 hours relative to L₃ @ SiO₂-500.

### Example 6

### Stability of Activated L₃ @ SiO₂-500 and L₃′ @ SiO₂-500

The stability of these catalysts can determined using solid-state FTIR spectroscopy for the sequence of ethylene hydrogenation catalysis, oxidation, ethylene hydrogenation catalysis, and then recarbonylation. These data are shown in FIGS. 6A-6D for 1787 cm⁻¹ (bridging) and 1988 cm⁻¹ (terminal) band intensity and wavenumber. The catalyst was first used for ethylene hydrogenation catalysis for 24 hours at 50° C. (as was done in Example #1, FIGS. 3A-3D), and then subjected to an oxidation treatment (60 mL/min dry air diluted in 10 mL/min He; T=50° C.) for 24 hours. A subsequent period of ethylene hydrogenation catalysis for 24 hours, by using the same reaction conditions as in FIGS. 5A and 5B, was performed prior to a final CO treatment (T=50° C.) to affect recarbonylation. These data sets show, for the catalyst L₃ @ SiO₂-500, terminal and bridging CO band intensities recover to their post-oxidation levels, which indicates that the catalyst is stable, as shown in FIGS. 6A and 6C. These band intensities were also stable during ethylene hydrogenation catalysis. The terminal CO band wavenumber was the same before and after the second ethylene hydrogenation catalysis period (FIG. 6A), which suggests that the stability of the metal cluster was maintained.

In contrast, the terminal CO band intensity for the catalyst L₃′ @ SiO₂-500 was not stable during the second ethylene hydrogenation catalysis (FIG. 6B) as the relative intensity increased from 0.3 to 0.4. The terminal CO band wavenumber observed after recarbonylation differed from the value observed prior to the second ethylene hydrogenation (FIG. 6B). These data are consistent with L₃′ @ SiO₂-500 being an unstable catalyst for ethylene hydrogenation after oxidation treatment.

### Example 7

### Chemical Modification of Activated L₃ @ SiO₂-500 after Activation

The change affected by the oxidation treatment on L₃ @ SiO₂-500 can be shown by following the decarbonylation during an oxidation treatment and recarbonylation by CO treatment processes using in-situ (time-resolved) solid-state FTIR spectroscopy as shown in FIG. 7 for 1988 cm⁻¹ (terminal) band intensity and wavenumber. The catalyst was subject to initial ethylene hydrogenation catalysis (as in Example 3, FIGS. 3A-3D) and subsequent oxidation by flowing dry air (as in Example 4, FIGS. 6A-6D) and recarbonylation by flowing CO (as in both FIGS. 3A-3D and 6A-6D). After oxidation treatment, the terminal CO relative IR band intensity does not recover to its as-made value, which indicates that oxidation affected an irreversible change in the catalyst. The terminal CO band wave number did recover to its as-made value suggesting that the stability of the metal cluster (and its interaction with the CO ligands) was maintained.

### Example 8

### Stability of L₃ @ SiO₂-500 in its Lifecycle from Inception to the Sequence of Catalysis, Oxidation, Recarbonylation

The stability of the catalyst L₃ @ SiO₂-500 was followed by ³¹P NMR characterizing as-made in Example 1, Example 2 after the sequence of initial C₂H₄ hydrogenation catalysis, and Examples 4 and 5 after the sequence of initial C₂H₄ hydrogenation catalysis, oxidation treatment, and subsequent C₂H₄ hydrogenation catalysis catalysts (FIG. 8). The spectrum characterizing the catalyst after initial ethylene hydrogenation catalysis (B) is similar to that of the as-made material (A), which is indicative of a stable catalyst, and reaffirms the conclusions drawn from data in FIGS. 2A-2B and 3A-3D. The sample from Example 4 after oxidation treatment and a second period of ethylene hydrogenation catalysis (C) is characterized by the disappearance of resonance in the spectrum near 18 ppm, which represents oxidation of the two equatorial CO ligands, and by the appearance of a resonance in the spectrum near 33 ppm. Resonance in the range of 24-35 ppm can be attributed specifically to phosphine oxide functionality. The aforementioned downfield ³¹P shift in C vs. A and B is attributed to the oxidation of phosphine. These data indicate that the catalyst has been irreversibly changed by oxidation characterized by a shift in the resonance in the spectrum to that of phosphine oxide. The oxidizing of the phosphine ligands to phosphine oxide creates a vacancy, as phosphine oxide is a labile ligand. These data are consistent with data in FIGS. 6A-6D and 7, which shows oxidation treatment affected an irreversible change that prevented recovery of the carbonyl band intensities to those observed prior to oxidation.

### Example 9

### Effect of C₂H₄ on the Catalytic Activity of L₃ @ SiO₂-500

The catalyst used in Examples 4 and 5 (after the sequence of catalysis, oxidation, and further catalysis) was exposed to pure C₂H₄ for 2 hours at 50° C. Subsequently, the catalytic activity for ethylene hydrogenation of the catalyst is measured (reaction conditions were the same as those used in Examples 4 and 5). The formation of ethane was increased by more than 25% (Table 2), from 1241 to 1576 ppm ethane, when comparing the rate prior to C₂H₄ exposure. This example shows that use of other gas treatments after an oxidation and ethylene hydrogenation catalysis sequence can further enhance activity.

Various modifications and alterations of this invention will become apparent to those skilled in the art without departing from the scope and spirit of the invention. Other objects and advantages will become apparent to those skilled in the art from a review of the preceding description.

We claim:

1. A method for activation of metal carbonyl clusters for catalysis comprising reacting the metal carbonyl cluster with an oxidative agent, with the oxidative agent reacting with a bound carbonyl group so as to unbind it from the cluster and leave behind a ligand in a different oxidative state, and recovering the activated open metal cluster.

2. The method of claim 1, wherein the metal carbonyl cluster is bound with three sterically protective ligands.

3. The method of claim 2, wherein the ligands are calixarene phosphine ligands.

4. The method of claim 1, wherein the metal carbonyl cluster activated is a closed metal carbonyl cluster.

5. The method of claim 1, wherein the oxidant is oxygen.

6. The method of claim 1, wherein the oxidant is a peroxide, hypochloride or permanganate.

7. The method of claim 1, wherein the activated open metal cluster obtained has vacant CO sites.

8. The method of claim 1, wherein the metal carbonyl cluster is Ir₄ carbonyl cluster.

9. The method of claim 1, wherein the metal cluster is Ir₄ carbonyl cluster bound with three calixarene phosphine ligands, and the activating agent is oxygen.

10. The method of claim 1, wherein the metal cluster is supported on a catalyst support.

11. The method of claim 10, wherein the catalyst support comprises silica and/or alumina, carbon, magnesia, or ceria.

12. The method of claim 10, wherein the metal cluster is Ir₄ carbonyl cluster bound with three calixarene phosphine ligands, the activating agent is oxygen, and the catalytic support is dehydroxylated silica.

13. A chemical catalytic reaction comprising conducting a chemical reaction in the presence of the activated metal cluster prepared in claim 1.

14. A chemical catalytic reaction comprising conducting a chemical reaction in the presence of the supported and treated activated metal cluster prepared in claim 10.

15. A chemical reaction comprising conducting a chemical reaction in the presence of activated metal cluster prepared in claim 12.

16. The chemical reactions of claim 14, wherein the chemical reaction is a hydrogenation reaction.

17. The chemical reaction of claim 16, wherein the hydrogenation reaction is hydrogenation of an olefin.

18. A method for activation of metal clusters comprising carbonyl ligands, phosphoric ligands or both, comprising reacting the metal cluster with an oxidative agent, with the oxidative agent reacting with a carbonyl group, phosphine group or both, to create vacancies in the metal cluster, and recovering the activated open metal cluster.

19. The method of claim 18, wherein the metal cluster comprises phosphine ligands, which phosphine ligands are oxidized to phosphine oxide to create a vacancy in the cluster.
